(19) United States
(12) Patent Application Publication
(10) Pub. No.: US 2025/0252643 A1
(43) Pub. Date: Aug. 7, 2025

(54) ARTIFICIAL INTELLIGENCE DEVICE FOR A HYBRID NEURAL RENDERING MODEL FOR 3D ANIMATION AND METHOD THEREOF

(71) Applicant: LG ELECTRONICS INC., Seoul (KR)

(72) Inventors: Prashant RAINA, Toronto (CA); Felix TAUBNER, Toronto (CA); Kevin FERREIRA, Toronto (CA); Eu Wern TEH, Toronto (CA); Mathieu TULI, Toronto (CA)

(73) Assignee: LG ELECTRONICS INC., Seoul (KR)

(21) Appl. No.: 19/044,247

(22) Filed: Feb. 3, 2025

Related U.S. Application Data
(60) Provisional application No. 63/548,822, filed on Feb. 1, 2024.

(51) Int. Cl. G06T 13/40; G06T 15/04; G06T 17/20

(52) U.S. Cl. CPC G06T 13/40; G06T 15/04; G06T 17/20

(57) ABSTRACT

A method for controlling a device can include receiving an input two-dimensional (2D) image, receiving a hybrid three-dimensional (3D) model including a first set of triangles forming a triangular mesh, and a second set of triangles with associated alpha map and neural feature maps, the vertices of both of the first and second sets of triangles including rigging information, and deforming the first and second sets of triangles of the hybrid 3D model based on 3D animation parameters and the rigging information, to generate deformed triangles. The method can further include rendering the deformed triangles based on rendering the first set of triangles using a texture mapping technique and rendering the second set of triangles using deferred neural rendering based on the neural feature maps and the alpha map to generate rendered triangles, and displaying an animated 3D object based on the rendered triangles and the input 2D image.

### CROSS-REFERENCE TO RELATED APPLICATIONS

This non-provisional application claims priority under 35 U.S.C. § 119(e) to U.S. Provisional Application No. 63/548,822, filed on Feb. 1, 2024, the entirety of which is hereby expressly incorporated by reference into the present application.

### BACKGROUND

### Field

The present disclosure relates to a device and method for receiving two dimensional (2D) images of an object, such as a face or head, and generating a three-dimensional (3D) animation of the object, in the field of artificial intelligence (AI). Particularly, the method can produce and use a hybrid neural rendering model for real-time animated 3D head avatars on edge devices.

### Discussion of the Related Art

Artificial intelligence (AI) continues to transform various aspects of society and help users by powering advancements in various fields, particularly with regards to computer graphics, animation and interactive applications.

Also, the field of 3D face animation has seen significant progress that has been driven by the demand for realistic and expressive facial representations in various applications, such as teleconferencing, virtual assistants, entertainment, virtual reality experiences and human-computer interaction.

However, existing methods face several challenges that limit their efficiency, accuracy and robustness. Existing approaches for 3D avatar creation and animation often struggle to accurately capture fine details such as hair, which is important for creating avatars that are both realistic and expressive. Simplified hair representations often fail to convey the intricacies, movements and nuances of real hair.

In addition, achieving high-fidelity rendering of complex avatars and objects typically requires substantial computational resources, which can be challenging for devices with limited processing capabilities. Detailed 3D avatars and objects often result in large file sizes, leading to increased storage requirements and longer download times, which is impractical for many applications.

Also, existing methods can be computationally expensive, especially for complex models with detailed hair and facial features. This can result in low frame rates and jerky animation on devices with limited processing power.

Further, some existing methods struggle to create avatars that exhibit natural and nuanced facial expressions and hair movements, which limits their ability to convey emotions and engage users effectively. Related art techniques for animating fine details such as hair can appear artificial and lack dynamic behavior (e.g., which can lead to the “uncanny valley” effect).

Accordingly, there exists a need for 3D avatar and 3D object generation and animation that can overcome these limitations.

Further, a need exists for a method that can receive two dimensional (2D) images of a face and generate a 3D animation of the face with high quality, realistic and expressive facial animations together with realistic fine details for other portions of the object, such as hair.

Also, a need exists for a method that is capable of creating realistic, expressive and efficient avatars that can be rendered in real-time on devices with limited resources.

### SUMMARY OF THE DISCLOSURE

The present disclosure has been made in view of the above problems and it is an object of the present disclosure to provide a device and method that can provide improved 3D animation, in the field of artificial intelligence (AI). Further, the method can generate and use a hybrid neural rendering model for real-time animated 3D head avatars on edge devices, which can efficiently and accurately generate and animate fine details, such as moving hair.

An object of the present disclosure is to provide a method for controlling an artificial intelligence (AI) device that can include utilizing an AI model to generate 3D facial animation from 2D video or images.

An object of the present disclosure is to provide a method for controlling an artificial intelligence (AI) device that can include receiving a series of two dimensional (2D) images along with camera and 3D morphable model (3DMM) parameters, in which a 3DMM mesh is used to represent the face and neck, while a prism lattice structure is constructed over regions such as the scalp and face to represent hair and other fine details. Further, the method includes training neural networks to create a deformable neural radiance field (NeRF) within the prism lattice, which is represented by a feature field and an opacity field that are both defined over a canonical space of the 3DMM, and a color prediction network converts neural features into colors based on viewing direction. After training, the AI model can be exported as a rigged triangular mesh with neural textures that can be rendered using mesh rendering, deferred neural rendering using precomputed neural feature textures, and post-processing to result in a 3D head avatar that can be animated in real-time, even on resource-constrained devices (e.g., mobile or edge devices).

Another object of the present disclosure is to provide a method for controlling an artificial intelligence (AI) device to train an AI model which can include receiving a set of images from a video of a subject along with camera information and 3D surface tracking data, fitting a 3D morphable model (3DMM) to the video, building a prism lattice structure around detailed areas like hair, which deforms along with the 3DMM. The method can further include defining two 3D neural fields over the canonical space, which include an opacity field and a feature field both represented as two neural networks, and using a color prediction neural network to covert neural features into colors given a viewing direction.

Also, the method to train the AI model can further include a first training pass for jointly training the opacity prediction network, the feature prediction network and the color prediction network by minimizing the error of a rendered image compared to a ground truth matted image from the input video, generating a rendered image by casting rays from each pixel in an image grid into a camera field of view, determining intersections of each ray with the 3D surface mesh and the prism lattice structure, sampling a learned 2D texture at the intersection point if the ray intersects the 3D surface mesh, transforming the intersection point to a corresponding point in a canonical space if the ray intersects the prism lattice structure, sampling feature and opacity fields of the NeRF at the corresponding point in the canonical space, generating a color from the sampled feature vector using the color prediction network, accumulating color and opacity values along the ray using neural volume rendering techniques to obtain a final color for the ray, and generating a rendered image based on the final colors of the rays.

Further the method to train the AI model can further include a second training pass on the trained opacity prediction network, the trained feature prediction network and the trained color prediction network to enforce two constraints in which the opacity field is biased in favor of binary values (e.g., values close to 0 (transparent) or 1 (opaque)), and each ray is encouraged to be associated with a single feature vector representing the first intersection of the ray with an opaque triangle of the prism lattice, in order to generate a final trained AI model.

Another object of the present disclosure is to provide a method for controlling an artificial intelligence (AI) device to export a trained AI model for use on an edge device, which can include rendering the hybrid model from multiple viewpoints to identify occluded triangles within the prism lattice structure and removing the occluded triangles, sampling the opacity field of the NeRF at a plurality of points on each remaining triangle in the prism lattice structure and removing triangles from the prism lattice structure if all sampled opacity values for a given triangle are below a predefined threshold, sampling feature vectors of the NeRF at a plurality of points on each remaining triangle in the prism lattice structure, generating texture maps in which each texture map stores a set of sampled opacity values and feature vectors corresponding to a respective triangle in the remaining prism lattice structure, computing UV texture coordinates for each vertex of each remaining triangle in the prism lattice structure to enable lookup at inference time, generating an opacity (alpha) map storing the sampled opacity values, optionally splitting the feature vectors (e.g., 8D) into multiple textures if a target platform does not support textures with the dimensionality of the feature vectors (e.g., into two 4D textures), and saving the vertices, triangle indices, texture coordinates, and rigging information of the remaining triangles in binary files to be used during inference time.

Another object of the present disclosure is to provide a method for controlling an artificial intelligence (AI) device during inference time that includes receiving or storing a hybrid 3D model that includes a first set of triangles forming a 3D surface mesh, the first set of triangles having associated color textures, an alpha map, and rigging information, and a second set of triangles representing a neural radiance field (NeRF), the second set of triangles having associated neural feature textures, an alpha map, and rigging information. The method further includes obtaining 3D animation parameters for deforming the 3D model, applying the 3D animation parameters to the rigging information to deform the first and second sets of triangles, rendering the deformed first set of triangles using textured triangular mesh rendering techniques during a first rendering pass, rendering the deformed second set of triangles during a second rendering pass by sampling the neural feature textures and alpha map, discarding pixels with an alpha value below a threshold, concatenating sampled neural features with a camera direction for the remaining pixels, and inputting the concatenated neural features and camera direction to a color prediction network to generate a color for each pixel. The method further includes applying image-space post-processing to the rendered first and second sets of triangles to generate a final image of the animated 3D avatar.

An object of the present disclosure to provide a method that include receiving an input two-dimensional (2D) image, receiving a hybrid three-dimensional (3D) model including a first set of triangles forming a triangular mesh, and a second set of triangles with associated alpha map and neural feature maps, the vertices of both of the first and second sets of triangles including rigging information, deforming the first and second sets of triangles of the hybrid 3D model based on 3D animation parameters and the rigging information, to generate deformed triangles, rendering the deformed triangles based on rendering the first set of triangles using a texture mapping technique and rendering the second set of triangles using deferred neural rendering based on the neural feature maps and the alpha map to generate rendered triangles, and displaying an animated 3D object based on the rendered triangles and the input 2D image.

It is another object of the present disclosure to provide a method, in which the first set of triangles correspond to a 3D surface mesh of a 3D morphable model, and the second set of triangles correspond to a neural radiance field (NeRF).

Yet another object of the present disclosure is to provide a method, in which the rendering the deformed triangles is based on a three-pass process that includes rendering the first set of triangles using the texture mapping technique, rendering the second set of triangles using the deferred neural rendering based on sampling the neural feature maps and the alpha map, discarding low-opacity pixels, and inputting sampled features and a camera direction to a color prediction neural network to generate a rendered image, and performing image-space post-processing on the rendered image to generate at least a portion of the animated 3D object.

An object of the present disclosure to provide a method that includes receiving predetermined weights for a color prediction neural network, and rendering the second set of triangles based on the color prediction neural network and the predetermined weights.

Another object of the present disclosure to provide a method, in which one or more triangles among the first and second sets of triangles have textures mapped to pre-computed textures, and the one or more triangles deform along with the triangles.

An object of the present disclosure to provide a method, in which the first set of triangles correspond to a head or neck region of a 3D head avatar, and the second set of triangles correspond to a hair region of the 3D head avatar.

Yet another object of the present disclosure to provide a method for controlling a device that includes receiving a video segment of a subject, fitting a three-dimensional (3D) morphable model to the video segment of the subject to obtain animation parameters for frames of the video segment, constructing a prism lattice structure over regions of the 3D morphable model designated for neural radiance field (NeRF) rendering, the prism lattice structure being configured to deform in tandem with the 3D morphable model, training a feature field neural network, an opacity field neural network, and a color prediction neural network within a corresponding canonical space to generate a trained feature field neural network, a trained opacity field neural network, and a trained color prediction neural network, and generating a hybrid 3D model including a 3D surface mesh for the 3D morphable model and a neural radiance field (NeRF) defined within the prism lattice structure based on the trained feature field neural network, the trained opacity field neural network, and the trained color prediction neural network.

An object of the present disclosure to provide a method, in which the training the feature field neural network, the opacity field neural network, and the color prediction neural network is based on rendering images by casting rays, determining ray intersections with the 3D surface mesh and the prism lattice, and sampling feature and opacity fields, comparing rendered images to ground truth images, and minimizing a difference between the rendered images and the ground truth images.

Another object of the present disclosure to provide a method that includes refining the trained opacity field neural network to favor binary values and associating each ray with a single feature vector from an opaque triangle of the prism lattice structure.

An object of the present disclosure to provide a method that includes pruning triangles from the prism lattice structure, creating texture maps for remaining triangles of the prism lattice structure, including an alpha map and two feature maps, obtaining a rigged triangular mesh, and outputting the rigged triangular mesh and the texture maps.

Yet another object of the present disclosure to provide a method that includes transmitting an exported hybrid 3D model based on the rigged triangular mesh and the texture maps to an external device.

Another object of the present disclosure is to provide a device including a display configured to display an image, a memory configured to store animation information, and a controller configured to receive an input two-dimensional (2D) image, receive a hybrid three-dimensional (3D) model including a first set of triangles forming a triangular mesh, and a second set of triangles with associated alpha map and neural feature maps, the vertices of both of the first and second sets of triangles including rigging information, deform the first and second sets of triangles of the hybrid 3D model based on 3D animation parameters and the rigging information, to generate deformed triangles, render the deformed triangles based on rendering the first set of triangles using a texture mapping technique and rendering the second set of triangles using deferred neural rendering based on the neural feature maps and the alpha map to generate rendered triangles, and display an animated 3D object based on the rendered triangles and the input 2D image.

An object of the present disclosure is to provide an AI device that includes a display configured to display an image, in which the controller is further configured to display, via the display, a 3D facial animation for an avatar with animated movements and hair movements.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4, including parts (a) and (b), shows examples of blendshapes and a mesh, according to embodiments of the present disclosure.

FIG. 5 illustrates an example flow chart for a method of generating a 3D animated avatar according to an embodiment of the present disclosure.

FIG. 6 illustrates an example overview of generating a 3D animated avatar, according to an embodiment of the present disclosure.

FIG. 7, part (a) illustrates an example of a volumetric field for hair in a hybrid 3D model which is defined over a prism lattice, and FIG. 7, part (b) illustrates an example of pruning the prism lattice to remove triangles that are invisible or occluded, according to embodiments of the present disclosure.

FIG. 8 illustrates an example architecture of an opacity prediction network included in an AI model, according to an embodiment of the present disclosure.

FIG. 9 illustrates an example architecture of a feature prediction network included in an AI model, according to an embodiment of the present disclosure.

FIG. 10 illustrates an example architecture of a color prediction network included in an AI model, according to an embodiment of the present disclosure.

FIG. 11 illustrates aspects of a renderer that shoots rays that intersect with both the face mesh and the prism lattice, according to an embodiment of the present disclosure.

FIG. 12 illustrates examples of head avatars reconstructed by the method, according to an embodiment of the present disclosure.

FIG. 13 illustrates examples of using the prism lattice for facial hair and a corresponding reconstructed avatar, and examples of frames showing deformations of a mustache in response to changes in the facial expression, according to embodiments of the present disclosure.

FIG. 14 illustrates an example flow chart for a method of training an AI model for 3D avatar animation, according to an embodiment of the present disclosure.

FIG. 15 illustrates an example flow chart for a method of exporting an AI model for 3D avatar animation, according to an embodiment of the present disclosure.

FIG. 16 illustrates an example flow chart for a method for 3D avatar animation during inference time, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

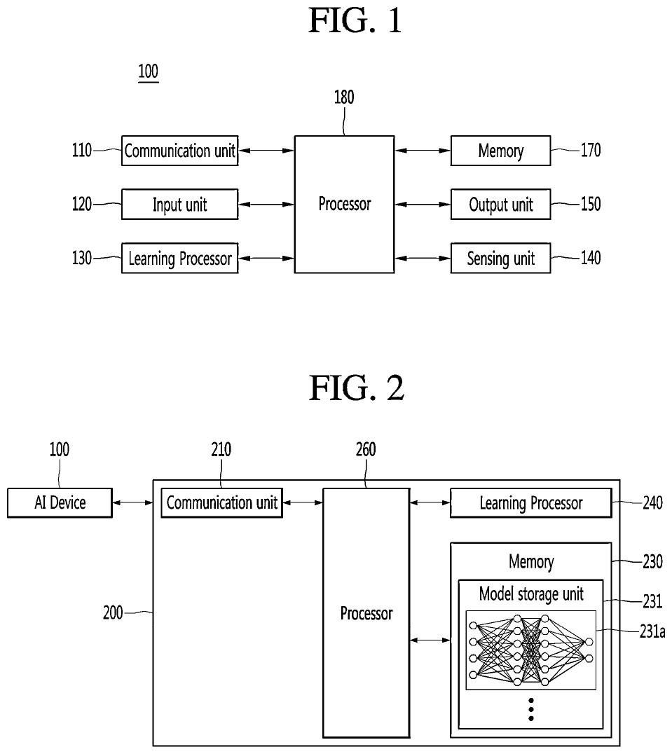

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

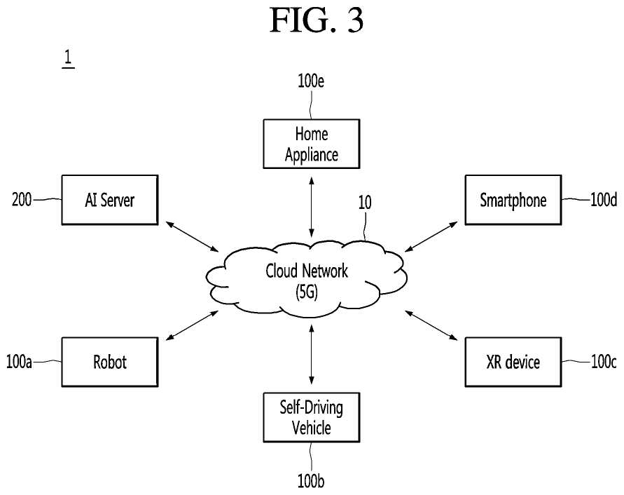

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information. For example, the display unit can display an animated 3D avatar.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement neural network driven animation and can animate facial expressions.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information from the user input and can determine an answer, carry out an action or movement, animate a displayed avatar or a recommend an item or action based on the acquired information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data.

The AI server 200 can be connected to at least one of the AI devices constituting the Al system 1, that is, the robot 100a, the self-driving vehicle 100b, the XR device 100c, the smartphone 100d, or the home appliance 100e through the cloud network 10, and can assist at least part of Al processing of the connected AI devices 100a to 100c.

At this time, the AI server 200 can learn the artificial neural network according to the machine learning algorithm instead of the AI devices 100a to 100e, and can directly store the learning model or transmit the AI model to the AI devices 100a to 100c.

At this time, the AI server 200 can receive input data from the AI devices 100a to 100c, can infer the result value for the received input data by using the learning model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement one or more of an animation method, digital avatar assistant, a question and answering system or a recommendation system using an animated avatar, etc. Also, the 3D avatar can perform virtual product demonstrations and provide user tutorials and maintenance tutorials. The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the Al server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation while providing an animated face with various expressions and emotions.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar with animated facial movements and expressions.

According to an embodiment, the AI device 100 can generate an animated 3D head avatar based on a 2D image.

According to another embodiment, the AI device 100 can be integrated into an infotainment system of the self-driving vehicle 100b in the form of a digital avatar, which can recognize different users and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, generating realistic 3D animated head avatars is difficult due to several factors, including complexity of facial movements and computationally expensive operations. Also, further challenges arise when trying to implement 3D animated head avatars one resource constrained devices, such as edge devices and mobile devices.

Developers typically animate faces and models using either blendshapes (e.g., predefined facial expressions) or by directly manipulating mesh vertices (e.g., individual points that define the 3D model). Blendshapes can be efficient but can lack detail and require artistic skill and labor to create.

In more detail, blendshapes are a set of predefined 3D shapes or states that a 3D model can smoothly transition between. These shapes can be used to alter the geometry of a character's face or body. Each blendshape represents a specific deformation or pose of the mesh, such as smiling, frowning, blinking, or any other facial expression or shape change.

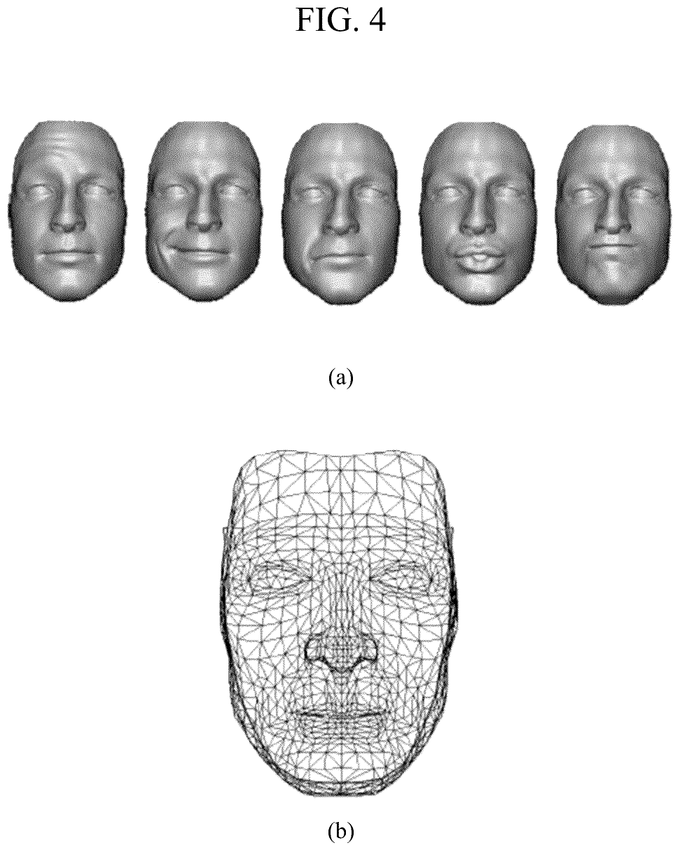

FIG. 4, part (a) shows an example of blendshapes that include a right eyebrow raise, a right lip corner smile, a right lip corn frown, a lip pucker and a chin raise. For example, blendshapes are primarily used for character animation. Instead of deforming the character's mesh using complex skeletal rigging and bone-based animations, blendshapes allow for precise control over the character's facial expressions and other deformations.

For example, a blendshape is a type of morph target used for a 3D model deformation technique where a set of predefined target shapes can be used to alter the geometry of a base mesh. Each blendshape can represent a specific expression or deformation, such as a smile, frown, or raised eyebrow, etc. By blending between these target shapes with varying weights, a wide range of facial expressions and body movements can be created. Blendshapes can be used for characters in video games, digital avatars and animated films.

Animators can create a range of expressions and deformations by blending between different shapes, hence the name “blendshapes.” However, blendshapes can struggle with capturing realistic movement of fine details, such as hair and facial and how such portion should deform as the face moves.

FIG. 4, part (b) shows an example of a mesh which is a polygonal surface that describes the geometric surfaces of a face or other object. For example, a mesh refers to a 3D model or object that is represented as a collection of vertices, edges, and faces (e.g., polygons) to create a 3D shape or structure.

Meshes can be used to represent and render objects and characters in 3D environments. A mesh defines the geometric structure of a 3D object by specifying the positions of its vertices in 3D space. These vertices are connected to form edges and faces, which define the shape of the object. Vertices are the individual points in 3D space that make up the mesh. Edges connect vertices, and faces are formed by connecting multiple vertices and edges to create flat surfaces (e.g., polygons, triangles or quadrilaterals). The combination of vertices, edges, and faces gives the mesh its shape.

In addition, a mesh can provide individual vertex control that offers a superior level of detail, enabling the portrayal of facial expressions that might prove challenging to achieve through blendshape blending alone. Also, mesh animation can allow developers a greater degree of creative freedom.

However, blendshapes and mesh animation often struggle to animate other fine details of the face and head, such as for hair, especially when trying to animate a 3D avatar on an edge device or a resource constrained device. For example, 3D morphable models (3DMMs) of heads are not sufficient on their own. They often do not model complex geometries such as hair or facial hair (e.g., mustache, sideburns, etc.).

According to an embodiment, the AI device and method can improve computer animation. For example, according to an embodiment, the method can include automatically generating realistic 3D facial animations based on a 2D input image. Further, the method can provide a more efficient and versatile solution that can deliver high-quality, real-time 3D head avatars on edge devices. The Prism Avatar AI model can use a hybrid mesh-volumetric approach that is designed for efficient animation and rendering, even within the constraints of resource-limited environments.

For example, a method for controlling an artificial intelligence (AI) device can include receiving a series of two dimensional (2D) images (e.g., input video sample) along with camera and 3D morphable model (3DMM) parameters, in which a 3DMM mesh is used to represent the face and neck, while a prism lattice structure is constructed over regions such as the scalp and face to represent hair and other fine details. Further, the method can include training neural networks to create a deformable neural radiance field (NeRF) within the prism lattice, which is represented by a feature field and an opacity field that are both defined over a canonical space of the 3DMM, and a color prediction network converts neural features into colors based on viewing direction. After training, the AI model can be exported as a rigged triangular mesh with neural textures that can be rendered using mesh rendering, deferred neural rendering using precomputed neural feature textures, and post-processing to result in a 3D head avatar that can be animated in real-time, even on resource-constrained devices (e.g., mobile or edge devices).

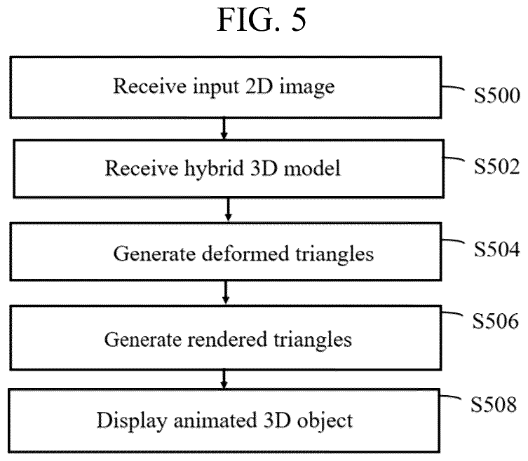

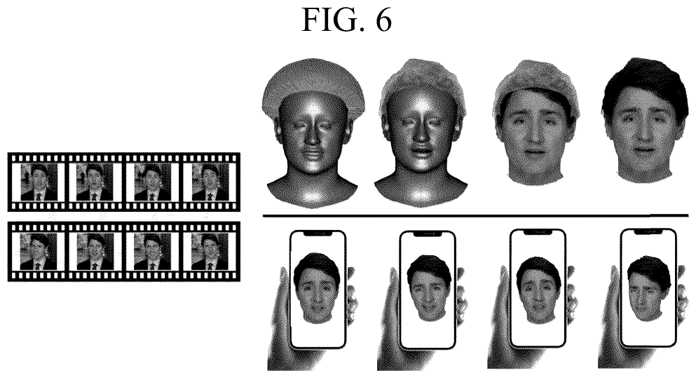

FIG. 5 shows an example flow chart of a method according to an embodiment. For example, according to an embodiment, a method for controlling an artificial intelligence (AI) device can include receiving, by a processor, an input two-dimensional (2D) image (e.g., S500), receiving a hybrid three-dimensional (3D) model including a first set of triangles forming a triangular mesh, and a second set of triangles with associated alpha map and neural feature maps, the vertices of both of the first and second sets of triangles including rigging information (e.g., S502), deforming the first and second sets of triangles of the hybrid 3D model based on 3D animation parameters and the rigging information, to generate deformed triangles (e.g., S504), rendering the deformed triangles based on rendering the first set of triangles using a texture mapping technique and rendering the second set of triangles using deferred neural rendering based on the neural feature maps and the alpha map to generate rendered triangles (e.g., S506), and displaying an animated 3D object based on the rendered triangles and the input 2D image (e.g., S508).

Also, the method can further include displaying 3D facial animation with animated movements along with hair movements.

According to embodiments, a method for controlling an artificial intelligence (AI) device can organized or divided into an AI model generating and training process, a model export process, and an inference process, which are discussed in more detail below.

FIG. 6 illustrates an example overview of generating a 3D animation for an avatar, according to an embodiment of the present disclosure.

As shown in FIG. 6, a method can be provided for creating real-time animated 3D head avatars optimized for mobile devices, which uses a hybrid mesh-volumetric model during training to combine a 3D morphable model (3DMM) with a deformable neural radiance field (NeRF) for representing fine details such as hair. The hybrid model can then be distilled into a compact, rigged mesh with neural textures for efficient rendering on resource-constrained hardware. In this way, dynamic 3D head avatars can be generated which achieve real-time animation at high frame rates with high quality even on mobile devices with improved efficiency and cross-platform compatibility.

As a brief overview, the prism avatar process can include receiving a series of matted images of a head, along with corresponding camera and 3D morphable model (3DMM) parameters. These parameters can be obtained through a head tracker to generate data for the subsequent training of a hybrid mesh-volumetric model of the head. An analysis-by-synthesis approach can be used to train the hybrid mesh-volumetric prism avatar model. According to embodiments, the overall AI model can be referred to as a prism avatar model or prism avatar.

For example, the model can be trained by comparing a rendered image to a ground truth image, and iteratively adjusting the parameters of the model to minimize the error between the two. The prism avatar model can be trained to reconstruct a 3D head avatar from a series of matted images, along with camera and 3DMM parameters, which is discussed in more detail at a later section.

The core of the model can be viewed as a combination of a 3D morphable model (3DMM) and a neural radiance field (NeRF). the FLAME model can be used as the 3DMM, but embodiments are not limited thereto and other types of 3DMMs can be used. For example, 3DMM FLAME model can serve to accurately represent much of the face and neck. However, the 3DMM may not effectively capture the complex geometry of details such as hair. To address this, the model can use a NeRF as a volumetric representation for areas such as scalp hair and facial hair.

For example, a Neural Radiance Field (NeRF) can be used for representing 3D scenes. It can use a neural network to encode the appearance of a given scene by mapping 3D coordinates and viewing directions to certain values, such as color and density values. Also, photorealistic views of the scene can be generated based on sampling this network along rays cast from a camera. This can help capture complex details and lighting effects that can be used to create highly realistic virtual environments and objects.

In addition, to ensure that the NeRF can move and deform in sync with the head, a rigged prism lattice structure can be constructed on top of the 3DMM mesh. Ray intersections with this prism lattice can then be mapped to the canonical space of the undeformed model, which facilitates the use of the NeRF. The NeRF itself can include three neural networks which allow for the sampling of view-independent neural features at points in the canonical space. Also, the 3D morphable model (3DMM) has a particular state when all animation parameters are set to their default value, which will be referred to as the canonical pose of the model, and the 3D space surrounding the model in its canonical pose is referred to as the canonical space.

Further, a hybrid rendering approach is used to train the NeRF in two stages. This approach incorporates both the textured FLAME mesh and the deformable NeRF to provide a comprehensive representation of the head. Finally, the hybrid model can be distilled into a compact triangle-based avatar model for export. This exported model is designed for efficient animation and neural surface rendering on edge devices such as the smart phone shown in FIG. 6 and can leverage a triangle rendering pipeline.

This hybrid approach can facilitate the training of the neural networks while ensuring that the final model can be efficiently rendered on edge devices by using precomputed neural textures for the volumetric regions, allowing for real-time animation without significant loss of quality.

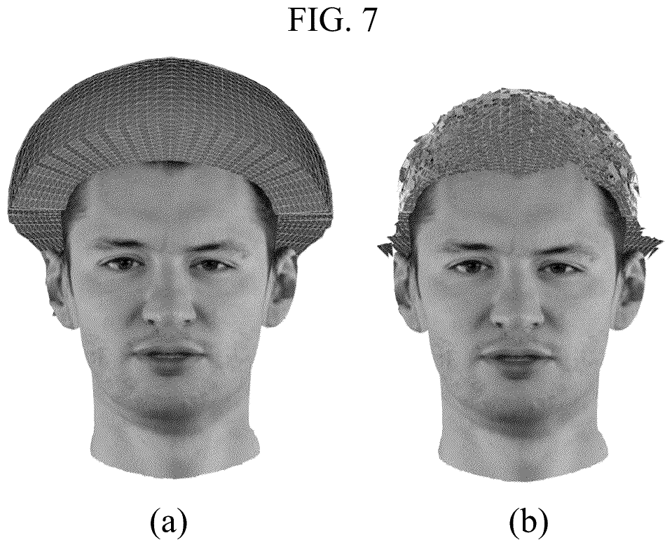

FIG. 7, including parts (a) and (b), shows an example of a prism lattice constructed on a 3DMM (e.g., FLAME mesh), according to an embodiment of the present disclosure.

The prism lattice can enable the NeRF to deform in conjunction with the 3D morphable model (3DMM). The construction of the prism lattice can include marking certain regions of 3DMM (e.g., FLAME mesh) as areas where the base of the prism lattice should be constructed. These areas can be marked manually, but embodiments are not limited thereto, and an automatic marking process can be implemented. These areas can include regions where the geometry of the subject is complex, such as the scalp for hair or the areas around the mouth for facial hair.

According to an embodiment, once the base regions are marked, the triangles within them can be subdivided to create a denser lattice. Each of these subdivided triangles is then extruded along the normal of each vertex to form a layer of prisms. This process of extrusion is repeated to create a stack of prism layers, with up to n layers being used where n is a positive number. The prism lattice can include up to 16 layers, but embodiments are not limited thereto. For example, more than 16 layers can be used, e.g., if the subject has very tall or long hair, etc.

For example, this layered approach can encompass the anticipated height of the hair or other fine-geometry structures being modeled. The extrusion process can be performed separately for each of the 400 FLAME shape and expression blendshapes. This helps integrate the prism lattice into the 3DMM, in order to ensure that the lattice deforms correctly as the underlying 3DMM is animated.

In addition, the vertices of the extruded prisms can inherit the linear blend skinning weights and pose corrective blendshapes of the base vertices. This allows the prism lattice to move in tandem with the skeletal animation of the 3DMM. In other words, the prism lattice is rigged to the 3DMM, such that its vertices deform in response to changes in shape, expression, and pose of the 3DMM, which can maintain the alignment of the NeRF with the head during animation.

According to an embodiment, for reconstructing facial hair around the face, additional lattices can be added around the sideburns and mouth areas, which allows the method to flexibly accommodate different facial features (e.g., see FIG. 13). For example, the prism lattice structure can act as a type of helmet or deformable cage around the regions of interest to enable the NeRF to accurately represent hair and other complex geometry, while also deforming with the underlying 3DMM. Also, portions of the prism lattice can be pruned away to improve efficiency (e.g., FIG. 7, part (b)), which is discussed in more detail at a later section.

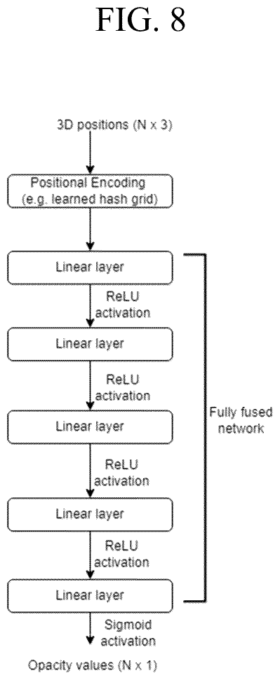

With reference to FIGS. 8, 9 and 10, according to an embodiment, the method can use three neural networks to represent the volumetric regions of the head (e.g., hair and facial hair) within the NeRF framework. These three networks are trained and work together to produce a view-dependent color for each point in the canonical space of the NeRF. For example, the prism avatar method can predict opacity (e.g., alpha) and view-dependent color in two steps, which allows for the use of alpha testing during rendering and optimizes for edge device performance. For example, the first step can produce a view-independent neural feature vector and the second step can produce a color conditioned on the view direction.

For example, according to an embodiment, alpha testing can be used to determine the visibility of pixels based on their opacity. Each pixel can have an associated alpha value representing its transparency (e.g., ranging from 0 to 1). During rendering, alpha testing can compare this alpha value to a predefined threshold (e.g., 0.5). If the alpha value of the pixel is below the predefined threshold, it can be considered as being fully transparent and discarded, preventing it from being drawn which can improve efficiency. This process can be used to render objects with transparent parts, such as, hair or facial, by selectively displaying only the opaque portions (e.g., the solid, non-transparent portions).

In more detail, the first of these three neural networks is the opacity prediction network, denoted as A (e.g., FIG. 8). The opacity prediction network can take a 3D point in the canonical space as input and outputs a single value representing the opacity (or alpha) of that point (e.g., an opacity field). For example, according to an embodiment, instead of using “density,” the prism avatar method can use opacity (or alpha) for the opacity prediction neural network.

For example, with reference to FIG. 8, the opacity predication network, A, can be defined based on Equation 1, below.

$${α}_{k} = ( {p}_{k} ; {θ}_{} ) : \to [ 0 , 1 ] \qquad [ Equation 1 ]$$

In Equation 1 above, pk represents a point in the canonical space of the NeRF, and the output (aₖ) can be a value between 0 and 1, where 0 is fully transparent and 1 is fully opaque. This predicted opacity (alpha) can then be used later to generate alpha textures for the exported model. Further, θ_{A} can represent the weights of the opacity predication network (A). Also, the network can be trained to predict binary values, favoring either 0 (transparent) or 1 (opaque).

According to an embodiment, with reference to FIG. 8, the opacity prediction neural network can have a specialized architecture designed for efficient and accurate prediction of opacity values within the 3D scene. This architecture can include two main components, such as a positional encoding layer and a fully fused network.

The positional encoding layer can serve to transform the input 3D coordinates into a higher-dimensional representation that captures spatial relationships more effectively. According to an embodiment, this can be achieved through a learned hash grid encoding that maps the input coordinates to a grid of trainable features. This encoding scheme can allow the network to learn complex spatial patterns and dependencies, which can improve the accuracy of opacity predictions. However, embodiments are not limited thereto and other encoding schemes can be used, such as multi-scale gride encoding or Gaussian encoding, etc.

Further in the example shown in FIG. 8, then the encoded coordinates can be passed to the fully fused network (fully fused Multi-Layer Perceptron (MLP)), which can include a series of linear layers with ReLU (Rectified Linear Unit) activation functions. For example, the fully fused network can include four linear layers, each followed by a ReLU activation, and a final linear layer followed by a sigmoid activation. This structure can enable the network to learn non-linear relationships between the input coordinates and the output opacity values. The ReLU activation functions can introduce non-linearity to allow the network to approximate complex functions, and the sigmoid activation in the final layer can ensure that the output values are bounded between 0 and 1, representing opacity levels. However, embodiments are not limited to, and more or fewer than five linear layers and corresponding ReLU activation functions can be used, according to embodiments and design considerations.

In this way, the positional encoding layer can capture spatial relationships, while the fully fused network can learn complex non-linear mappings between coordinates and opacity, in order to perform accurate and efficient opacity prediction which can improve realism and efficiency of the 3D rendering process.

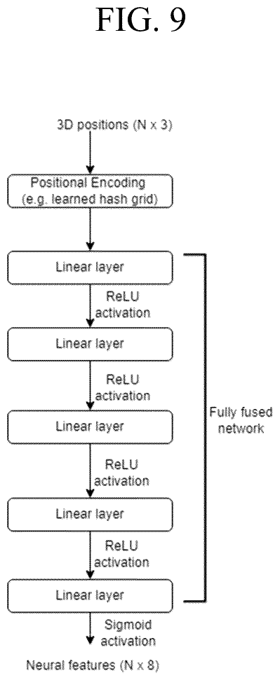

Further in this example, with reference to FIG. 9, the second neural network is the feature prediction network, denoted as F. The feature prediction network also takes a point in the canonical space as input (pₖ), but it outputs an 8D neural feature vector (fₖ) associated with that point. This neural feature vector (e.g., feature field) implicitly describes the color of that point when viewed from different directions.

For example, the feature prediction network, F, can be defined based on Equation 2, below.

$${f}_{k} = ( {p}_{k} ; {θ}_{} ) : \to {[ 0 , 1 ]}^{8} \qquad [ Equation 2 ]$$

In Equation 2 above, pk represents a point in the canonical space of the NeRF, and the output is an 8-dimensional feature vector (fₖ). This output can used to generate a neural texture for the exported model. Further, θ_{F} can represent the weights of the feature predication network (F). The feature vector is view-independent and can be used in combination with a view direction to produce a view-dependent color.

According to an embodiment, with reference to FIG. 9, the feature prediction neural network can have an architecture designed to efficiently process 3D coordinates and produce a feature vector that implicitly encodes the color of a point when viewed from different directions. The input to the feature network is a 3D point in the canonical space of the NeRF, and its output is an 8-dimensional feature vector.

Similar to the opacity prediction network, the architecture of the feature prediction network can include a learned hash-grid positional encoding layer that transforms the 3D input coordinates into a higher-dimensional space. The learned hash grid positional encoding maps the 3D input coordinates to a higher-dimensional feature vector that can be processed by the fully fused MLP, and can allow the network to maximize its capacity for the portions of the unit cube occupied by the volumetric data. This can help capture details in the 3D space.

The output of the positional encoding layer can then be fed into a fully fused Multi-Layer Perceptron (MLP). This MLP can include a series of linear layers each followed by a ReLU activation, which are designed to extract relevant features from the positional encoding and to predict the 8D neural feature vector.

According to an embodiment, the fully fused MLP of the feature prediction network can include a first linear layer that transforms the input feature vector from the positional encoding to a higher-dimensional space, a ReLU (Rectified Linear Unit) activation function applied to the output of the first linear layer which can introduce non-linearity to the network, a second linear layer that further transforms the data, a second ReLU activation function applied to the output of the second linear layer, a third linear layer that further transforms the data, a third ReLU activation function applied to the output of the third linear layer, a fourth linear layer and a fourth ReLU activation function applied to the output of the fourth linear layer, and a fifth linear layer and a sigmoid activation function applied to the output of the fifth linear layer, which produces an 8-dimensional vector.

However, embodiments are not limited to, and more or fewer than five linear layers and corresponding ReLU activation functions can be used, according to embodiments and design considerations.

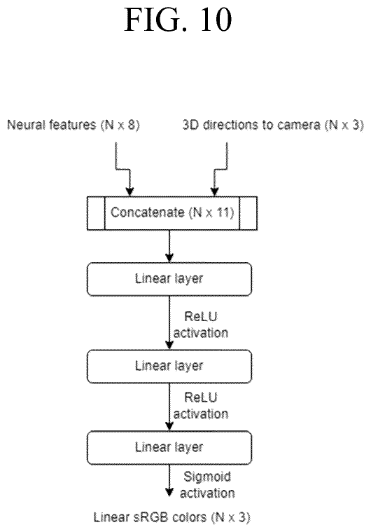

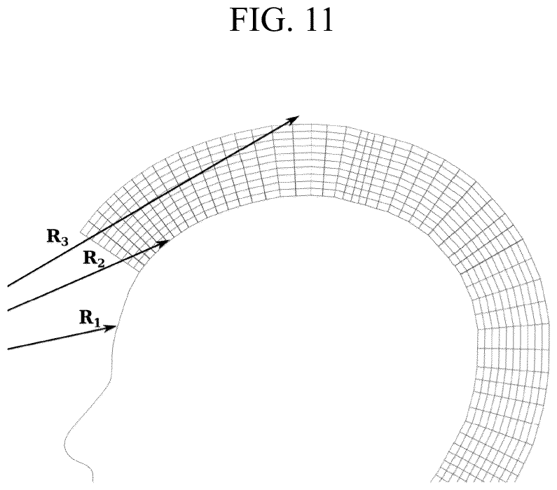

With reference to FIG. 10, the color prediction network, denoted as C, is used to predict the final color given a viewing direction and the 8D neural feature vector generated by the feature prediction network.

For example, the color prediction network, C, can be defined based on Equation 3, below.

$${c}_{k} = 𝒞 ( {f}_{k} , d ; {θ}_{𝒞} ) 𝒞 {: [ 0 , 1 ]}^{8} \times {[ - 1 , 1 ]}^{3} \to {[ 0 , 1 ]}^{3} \qquad [ Equation 3 ]$$

In Equation 3 above, the inputs are the 8D feature vector (fₖ) from the feature prediction network and a 3D ray direction (d), and the output is a 3D linear RGB color (cₖ). Further, θ_{c} can represent the weights of the color predication network (C). The color prediction network can be implemented as a small multi-layer perceptron (MLP) that concatenates the 8D neural feature vector with a 3D direction, passing the result through two hidden layers of 16 neurons with ReLU activations, and a sigmoid activation at the end to produce the final RGB color. The weights of this network can be exported along with the avatar for deferred neural rendering on the edge device.

According to an embodiment, as shown in FIG. 10, the color prediction neural network can have a concatenation layer followed by first, second and third linear layers with ReLU activation functions therebetween, followed by a sigmoid activation function to output linear sRGB colors. Also, the linear sRGB colors can be converted to gamma-compressed sRGB color in the post-processing rendering pass.

In more detail, the prism avatar method employs a hybrid rendering approach that can combine the strengths of both surface and volume rendering techniques to create detailed and realistic 3D head avatars. For example, the method can accurately capture both the well-defined surfaces of the face and the complex, volumetric structures such as hair and facial hair.

Further, the hybrid rendering involves different rendering methods for the base 3DMM (e.g., base FLAME mesh) and the regions enclosed by the prism lattice which are treated as deformable NeRFs.

According to an embodiment, the base mesh (e.g., for the face area) can be handled as a textured mesh with a learned texture and alpha map. In contrast to the face area, the areas within the prism lattices (e.g., hair region) can be rendered using neural fields (e.g., NeRFs). This hybrid approach can allow for the efficient use of GPU ray tracing hardware for the volumetric parts of the model, while also leveraging the efficiency of mesh rendering for the rest of the model.

Further in this example, in the hybrid rendering process, rays are cast from the camera through the scene. These rays interact with the 3D model in different ways depending on whether they intersect the base 3DMM mesh (e.g., FLAME mesh) or the prism lattice.

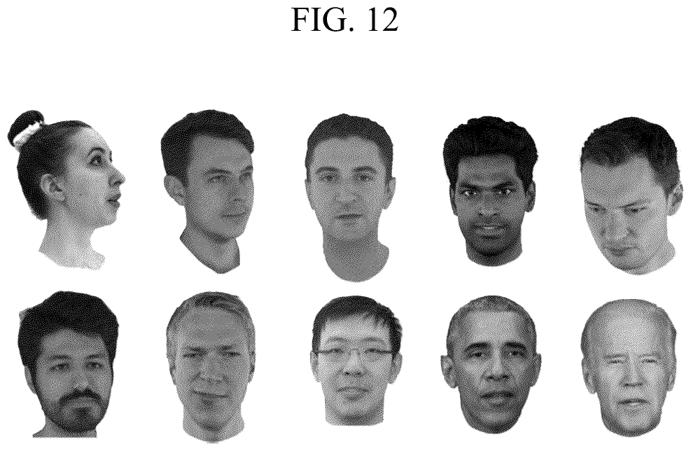

For example, when a ray intersects the base mesh (e.g., the face region), the intersection point is considered opaque (e.g., that point is assigned an opacity of 1), and its color is sampled directly from a learned 2D texture associated with the face (e.g., see ray R1 in FIG. 11).

Also, rays that intersect with the triangles that fill the mouth cavity are also considered opaque and are rendered with a separate learned 2D texture. For example, to handle the mouth interior, the hole in the 3DMM mesh can be filled for the mouth cavity, and the triangles of the sealed hole can be rendered with a learned 2D texture for inside the mouth.

In addition, if a ray intersects a triangle within the prism lattice, the intersection point is transformed into the canonical space (e.g., see ray R3 in FIG. 11). The opacity and feature fields are sampled at this transformed point, and the color network then converts the sampled feature vector into a color based on the viewing direction. The color and opacity of these neural fields are then accumulated along the ray using neural volume rendering techniques to determine the final color of the ray. For example, the ray can continue to collect intersections with the prism lattices up to a set maximum (e.g., 64 intersections). Also, a triangle bounding volume hierarchy (BVH) can be used to accelerate ray intersection tests.

Further, if a ray (e.g., see ray R2 in FIG. 11) intersects the prism lattice before terminating on the base mesh, its color can be obtained by interpolating the volume rendering integral before the last intersection with the color of the final intersection by using the accumulated opacity as the interpolation factor.

According to an embodiment, the training process for the hybrid model can be divided into two stages. During the first stage of training, all three neural networks, the opacity network, the feature network, and the color prediction network, are trained jointly by minimizing the error between rendered images and ground truth matted images from input videos. The color of the ray is determined by accumulating the colors and opacities sampled along the ray. Specifically, the integrated pixel intensity along the ray is computed as a sum of the product of the transmittance, the opacity, and the color prediction at each intersection point, as shown in Equations [4] and [5] below.

$$I ( o , d ) = {\sum }_{k = 1}^{K} {T}_{k} {α}_{k} 𝒞 ( ℱ ( {p}_{k} ) , d ) \qquad [ Equation 4 ]$$

$${T}_{k} = {\prod }_{l = 1}^{k - 1} ( 1 - {α}_{l} ) \qquad [ Equation 5 ]$$

Here, aₖ is either computed using the opacity network for ray-lattice intersections, or is assigned a fixed opacity of 1 in the situation of ray-FLAME intersections. The C term is replaced with a color sampled from the learned face texture for ray-FLAME intersections.

According to an embodiment, the training process includes a second stage of training to further refine the model and to mimic the effects of triangle rasterization and deferred neural rendering. In this stage, each ray is associated with a single feature vector, which is a weighted average of predicted feature vectors along the ray. The color network C is executed once per pixel. The ray integration in the second stage is given by equation [6] below.

$$I ( o , d ) = 𝒞 ( {\sum }_{k = 1}^{K} {T}_{k} {α}_{k} ( {p}_{k} ) , d ) \qquad [ Equation 6 ]$$

In addition, during this second training stage, in situations where the ray intersects both the lattice and the FLAME mesh, a linear interpolation is performed between the color obtained from the volume rendering and the color of the FLAME mesh, using the accumulated opacity as the interpolation factor, as shown in equation [7], below. For example, if the final ray intersection K hits the FLAME mesh, the process first computes the intensity excluding that intersection as Iₗₐₜ. Then, the process samples the color of the FLAME mesh Iflame at the intersection point from the learned texture, and then linearly interpolate between the two colors based on the accumulated transmittance up to that point.

$$I = ( 1 - {T}_{K} ) {I}_{lat} + {T}_{K} {I}_{flame} \qquad [ Equation 7 ]$$

This stage also encourages the opacity field to be biased in favor of binary values (either transparent or opaque) and ensures that each ray is associated with a single feature vector.

In addition, two losses are minimized in both training stages: a photometric loss and an alpha or silhouette regularize. For example, the photometric loss, Lₚₕₒₜₒ, is an l1 log-sRGB loss and is used to minimize the error between the rendered and ground truth image. The alpha or silhouette regularizer, Lₐₗₚₕₐ, is the mean square of the predicted alpha Σₖ₌₁^{K}Tₗαₖ for all pixels corresponding to the ground truth background mask and encourages transparency in regions corresponding to the background.

In the second stage, there can be an additional goal of binarizing the predicted alpha values, by using a straight through estimator to make the model suitable for alpha testing. Also, according to an embodiment, in order to better stabilize training, the model interpolates between the binarized and non-binarized losses during training. For example, the process can include calculating two versions of all losses, e.g., with and without the straight-through estimator. The process can gradually interpolate from the non-binarized losses to the binarized losses over the course of training.

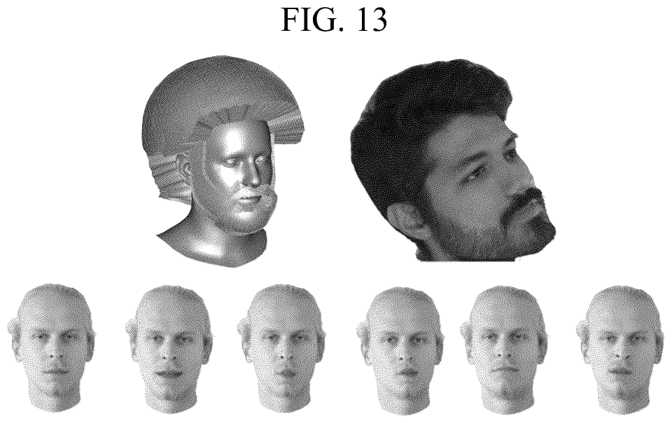

FIG. 12 shows examples of reconstructed avatars created by the prism avatar method. As can be seen, the hair is accurately reconstructed along with the face.

Also, FIG. 13 shows additional results highlighting the performance of the prism avatar method on facial hair. The prism lattice covering the face may not only be used to accurately reconstruct facial hair, but also to deform the hair in response to different facial expressions.

For example, in FIG. 13 (top), using a prism lattice which covers portions of the face allows the method to reconstruct facial hair. Thick dark hair and thin blond hair can both be reconstructed by the method. In FIG. 13, the top portion shows an example of the prism lattice for facial hair and an example of a reconstructed avatar. Also, in FIG. 13, the bottom portion shows example frames showing the deformation of the mustache in response to changes in the facial expression.

Also, while examples may describe a method utilizing a hybrid 3D model that combines a triangular mesh with texture maps for the face and neck of a head avatar and a collection of triangles with associated neural textures for the hair of the avatar, embodiments are not limited thereto. For example, embodiments of the method utilizing a hybrid 3D model described herein can be applied to any type of 3D object where one portion can be represented with a mesh and another portion having finer details can be represented with the triangles with associated neural textures corresponding to the NeRF (e.g., animals, vehicles, food, plants and other objects, etc.).

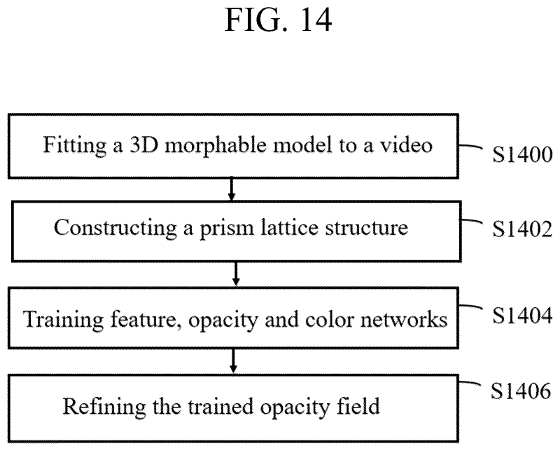

FIG. 14 shows an example of a training process according to an embodiment. For example, a method for training a hybrid 3D model having a 3D surface mesh and a neural radiance field (NeRF) defined within a prism lattice structure, can include fitting a 3D morphable model to a video of a subject to obtain animation parameters for each frame of the video (e.g., S1400).

Also, the method can further include constructing a prism lattice structure over regions of the 3D morphable model designated for NeRF rendering, in which the prism lattice structure deforms in tandem with the 3D morphable model (e.g., S1402), and training a feature field network, an opacity field network and a color prediction network within the canonical space by a) rendering images by casting rays, determining ray intersections with the 3D surface mesh and prism lattice, and sampling the feature and opacity fields, b) comparing the rendered images to ground truth images, and c) minimizing the difference between the rendered images and the ground truth images (e.g., S1404).

In addition, the method can further include refining the trained opacity field to favor binary values and associating each ray with a single feature vector from an opaque triangle of the prism lattice (e.g., S1406).

In more detail, training process for the deformable NeRF Hybrid Model can include obtaining a set of images captured from a video of the subject. This image data can be accompanied by camera information, 3D surface tracking data, and background matting. According to an embodiment, these supporting data elements can be derived from a separate data processing pipeline. Also, the surface tracking data fits a template defined by a 3D morphable model to represent the subject in the video. This 3D morphable model is a triangular mesh, complete with rigging information at each vertex. This rigging information can allow the model to morph and deform according to animation parameters. The 3D surface tracking process determines the optimal morphing and animation parameters for each frame of the input video.

Also, certain portions of the 3D surface template can then be designated as bases for hair or other structures that benefit from NeRF rendering for accurate reconstruction. A multi-layered prism lattice structure is subsequently constructed over these marked regions of the surface template. This lattice can be set to have sufficient height to encompass hair and other anticipated fine-geometry structures. During lattice construction, the rigging information from the template vertices is transferred to the nearest prism vertices. This can ensure that the lattice deforms in conjunction with the surface template.

In addition, as discussed above, the morphable model possesses a specific state when all animation parameters are at their default values. This state can be defined as the canonical pose of the model. The 3D space surrounding the model in its canonical pose can be referred to as the canonical space. Within this canonical space, two 3D neural fields are defined which include a feature field and an opacity field. Both fields are represented by neural networks that undergo training. The feature field produces a neural feature at any given 3D point that implicitly describes the color of that point from various viewing directions.

Further, a lightweight color prediction network is provided to convert the neural features into actual colors based on the viewing direction. All three networks (e.g., feature field, opacity field, and color prediction networks) are trained simultaneously. This joint training minimizes the difference between a rendered image and a corresponding ground truth matted image from the input video. As discussed above, the rendered image is generated by casting 3D rays from each pixel in the image grid into the camera's field of view. The color at each pixel is then computed based on the intersections of these rays with both the 3D surface and the neural fields.

Also, rays intersecting the surface (e.g., the face mesh) sample a learned 2D texture. These rays may not be processed further. However, when a ray intersects a triangle within the prism lattice, the intersection point is transformed to its corresponding location in canonical space. At this point, the feature and opacity fields are sampled. The color network then converts the resulting feature vector into a color. According to embodiments, neural volume rendering techniques can be employed to accumulate the color and opacity information from the neural fields along the ray to determine the final color of that ray.

After the initial training of the neural fields and color network, a second, similar training pass is performed. This second pass can enforce two key constraints. First, the opacity field can be biased towards binary values, e.g., values close to either 0 (transparent) or 1 (opaque). Second, each ray can be encouraged to be associated with only a single feature vector. This vector should represent the first intersection of the ray with an opaque triangle of the prism lattice.

Upon completion of this two-stage training process, the networks can be considered as being fully trained. While these trained networks can generate images and videos (e.g., on desktop-class hardware having advanced computing resources), they are not yet optimized for resource-constrained devices. The training process is designed to facilitate a subsequent export of the model into a format suitable for inference on mobile devices. This export process is detailed in the following section.

According to an embodiment, the method can include a model export process for transforming the trained hybrid mesh-volumetric model into a compact, efficient and animatable representation suitable for real-time rendering on resource-constrained edge devices. The export process can optimize the model for mobile and web-based platforms by converting the neural volume information into a format that can be compatible with existing graphics pipelines. The final exported model can include a rigged triangular mesh with accompanying texture maps for deferred neural rendering combined with standard texture rendering.

In more detail, the model export process can include pruning the prism lattice to remove triangles that are either occluded or transparent. This can be achieved by rendering the hybrid model from various viewpoints and angles used during training.

Further, rays can be cast from each pixel toward the prism lattice, and the opacity values at the hit points are determined by transforming the points to the canonical space and passing them through the trained opacity network.

For example, if the predicted opacity is below a threshold (0.5), the ray continues, otherwise the triangle hit by the ray is recorded. This process can identify the visible triangles from different viewpoints and the prism lattice can then be re-indexed without the pruned triangles. In this way, the number of triangles can be significantly reduced, which reduces the amount of memory needed and improves rendering efficiency. The pruning process is illustrated in FIG. 7, in which part (a) shows the lattice before pruning, and part (b) shows the lattice after pruning.

Further in this example, the model export process can further include converting the neural volume data into texture maps for efficient rendering. For example, three large texture maps can be generated for deferred neural rendering of the lattice triangles, which include an alpha map and two feature maps.

In addition, the 8D feature vectors can be split into two sets of RGBA channels, which enables texture compression. Each remaining triangle in the prism lattice can be assigned to a 16×16 square cell of each texture map. These texture maps can be regarded as grids of these square cells, with the height and width of the grids chosen to be as close to square as possible, minimizing both dimensions. For example, the height and width of the grids can be obtained by taking the square root of the number of lattice triangle and rounding up.

Also, for each square cell, a 16×16 grid of 3D points can be uniformly sampled on the corresponding canonical lattice triangle. These sampled 3D points can then be passed through the opacity and feature networks to obtain the values for the alpha and feature maps. A low distortion mapping from a square to a triangle can ensure that the whole square cell is used to store data for the triangle. Also, to enable efficient rendering, each triangle can be split in two so that the UV coordinates point to all four corners of the corresponding square region of the texture map.

In addition, the model export process can include the creation of a texture and alpha map for the FLAME mesh and the mouth interior (e.g., for the face and neck regions). The final exported model also includes the weights of the color network (C) to be used in a neural shader (e.g., the neural shader can reside locally on the edge device). Also, in order to maintain compatibility with existing rendering pipelines, vertices that have multiple UV coordinates corresponding to the same triangle vertex can be duplicated such that each vertex has a unique UV coordinate.

According to an embodiment, the final exported model can include the following elements: vertices, triangle indices, texture coordinates, and rigging information for the remaining triangles (e.g., saved as binary files); a base triangular mesh (e.g., the FLAME mesh) with an associated color texture and alpha map (e.g., for the face and neck regions), an unstructured collection of triangles (e.g., from the prism lattice) with an associated alpha map and neural feature texture maps; and the weights of the color prediction network C.

In this way, the export process can transform the complex neural volume data into a format that is optimized for real-time rendering, which is compatible with the limited resources of mobile devices and other edge platforms. For example, the final exported model can be transmitted to an edge device such as a mobile device, tablet, smartphone, etc.

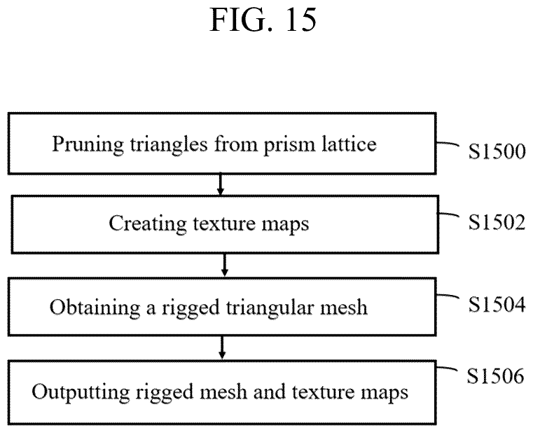

FIG. 15 shows an example of a model export process according to an embodiment. For example, the method can include pruning triangles from prism lattice (e.g., S1500), creating texture maps for remaining triangles which include an alpha map and two feature maps (e.g., S1502), obtaining a rigged triangular mesh (e.g., S1504), and outputting the rigged triangular mesh and the texture maps (e.g., S1506).

In more detail, pruning triangles from prism lattice can include identifying and removing triangles within the prism lattice that are either occluded or transparent. As discussed above, rays can be cast from the camera viewpoint through each pixel of the training images towards the prism lattice. The points where these rays intersect the lattice can then be transformed into the canonical space of the 3D model.

In addition, the transformed intersection points can be passed through the trained opacity network, which predicts the opacity (alpha) value for each point, indicating how transparent or opaque that point is. If the predicted opacity is below a predefined threshold (e.g., 0.5), the triangle is considered transparent and removed. If the opacity is above the threshold, then the triangle is included in the remaining pruned lattice. This process can be repeated using multiple viewpoints to ensure a comprehensive assessment of each triangle's visibility. After analyzing all viewpoints, the prism lattice can be re-indexed to exclude the triangles that were identified as occluded or transparent.

Creating the texture maps for the remaining triangles can include creating an alpha map and two feature maps. As discussed above, each of the remaining triangles in the prism lattice can be assigned a 16x16 square cell within each texture map, and 3D points can be sampled on the corresponding canonical lattice triangle.

Further in this example, each of the sampled 3D points can then be passed through the trained opacity network to obtain an alpha value, which will be stored in the alpha map. These same points are also passed through the trained feature network to generate an 8D feature vector.

The 8D feature vectors can be split into two sets of RGBA channels so that the two 4D feature maps can be saved and compressed as PNG. This splitting can be done to accommodate platforms that may not allow textures with more than 4 channels.

Then, the resulting alpha and feature values can be stored in the corresponding cells of the texture maps. These texture maps store the information for rending the complex geometric details captured by the prism lattice.

Obtaining the rigged triangular mesh can include combining the 3DMM mesh (e.g., the FLAME mesh) and the triangles from the prism lattice. As discussed above, the FLAME mesh is a 3D morphable model that provides the base geometry for the head, and the triangles from the prism lattice can be added to the FLAME mesh in regions where more complex geometric details, like hair, are needed.

Further, the vertices of both the FLAME mesh and the prism lattice triangles have associated rigging information. This rigging information defines how the vertices move and deform in response to animation parameters, such as blendshape coefficients and skeletal joint rotations. To ensure compatibility with existing rendering pipelines, any vertices in the mesh that have multiple UV coordinates can be duplicated so that each vertex has a unique UV coordinate.

Then, the method can include outputting the rigged triangular mesh and texture maps. For example, the processed data can be saved into a format that is suitable for rendering. The saved information can include the vertices, triangle indices, texture coordinates, and rigging information of the remaining triangles, which are saved as binary files. In addition, the weights of the color network (C) are exported for use in the neural shader on the rendering platform.

In this way, a hybrid 3D model can be produced that combines a triangular mesh with texture maps and a collection of triangles with associated neural textures. For example, the triangles can have textures mapped to pre-computed textures, which deform along with the triangles. This hybrid model can then be rendered on mobile and edge devices utilizing deferred neural rendering techniques.

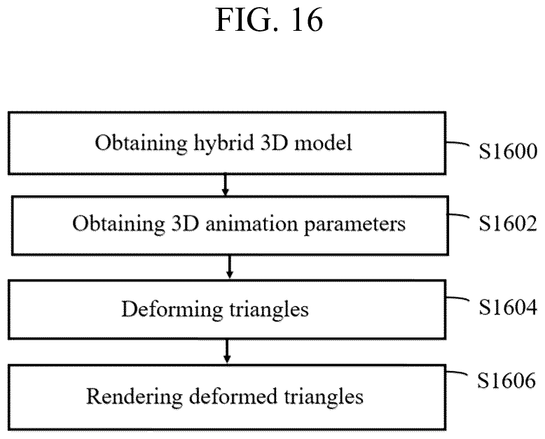

FIG. 16 shows an example of an inference process according to an embodiment. For example, a method for controlling a device to render an animated 3D model can include obtaining a hybrid 3D model including a first set of triangles forming a triangular mesh with associated color texture and alpha map, and a second set of unstructured triangles with associated alpha map and neural feature maps, in which the vertices of both sets of triangles include rigging information (e.g., S1600), and obtaining 3D animation parameters, such as blendshape coefficients or skeletal joint rotations, from either an on-device or a remote source (e.g., S1602).

Also, the method can further include deforming the triangles of the hybrid 3D model based on the received 3D animation parameters and the rigging information (e.g., S1604), and rendering the deformed triangles in a three-pass process that includes rendering the first set of triangles using standard texture mapping techniques, rendering the second set of triangles using deferred neural rendering based on sampling the neural feature maps and alpha map, and discarding low-opacity pixels, inputting sampled features and a camera direction to a color prediction neural network, and performing image-space post-processing on the rendered image (e.g., S1606).

In more detail, according to an embodiment, a method including an inference process can include executing an application on a device such as a mobile or edge device (e.g., functioning either as a native application or as a web application within a browser, etc.).

Further, the application can receive and manage a hybrid 3D model exported from the training process. The hybrid 3D model can include two distinct sets of triangles. The first set of triangles can a standard triangular mesh with an associated color texture and alpha map. The second set of triangles can be an unstructured collection of triangles with an associated alpha map and neural feature maps. These unstructured triangles can be rendered by the device using deferred neural rendering techniques. Also, all vertices within both sets of triangles contain rigging information. This rigging information defines how the positions of these vertices change during 3D animation.

Further in this example, the application can acquire 3D animation parameters. The 3D animation parameters can take the form of blendshape coefficients, skeletal joint rotations, or a combination of both. The 3D animation parameters can originate from an on-device generative model or be received from a remote device.

In addition, for each frame, the 3D animation parameters can be used to drive the deformation of the triangles within the exported model. This deformation leverages the rigging information associated with each vertex. Blendshape calculations can occur on the CPU, while linear blend skinning of skeletal joints can be handled within a vertex shader for efficiency, but embodiments are not limited thereto.

The deformed triangles can then be rendered into an image from the camera's perspective. This rendering process can employ a three-pass approach, in which each pass can be implemented as a fragment shader. For example, the first pass can render the non-neural components of the 3D model (e.g., the face and neck portions). This can use standard techniques for rendering textured triangular meshes, such as those used for the face portion of the 3DMM (e.g., the FLAME model).

Further in this example, the second rendering pass can focus on the second set of triangles derived from the neural volumes. These triangles can be rendered using the precomputed neural feature textures. Also, the opacity texture is sampled across each triangle. Any pixels having low opacity can be immediately discarded. Then, each 8D neural feature sampled at a given pixel can be combined with the 3D camera direction. This combined input can then be fed into an on-device implementation of the color prediction neural network (e.g., the device executing the application can have previously received the network weights during the export process). The output of this color prediction network can be a linear sRGB color value.

Also, the third rendering pass can include executing image-space post-processing. This post-processing can operate on the colors generated in the first two passes. An example of this post-processing is the conversion from linear sRGB color to gamma-compressed sRGB color. However, embodiments are not limited thereto. An animated 3D avatar can be displayed based on the hybrid 3D model and the two sets of triangles.

Also, while non-limiting examples may describe a method utilizing a hybrid 3D model that combines a triangular mesh with texture maps for the face and neck of a head avatar and a collection of triangles with associated neural textures for the hair of the avatar, embodiments are not limited thereto. For example, embodiments of the method utilizing a hybrid 3D model described herein can be applied to any type of 3D object where one portion can be represented with a mesh and another portion having finer details can be represented with prism lattice and neural fields (e.g., animals, vehicles, plants and other objects, etc.).

The evaluate the performance of the overall AI model (e.g., Prism Avatar) according to embodiments, results were measured and evaluated.

As shown in Table I below, the AI model (e.g., Prism Avatar) according to the embodiment performs on comparably with other methods, even though the prism avatar method can be run on mobile devices with constrained resources while the related art methods cannot (e.g., the related art methods require advanced desktop computing hardware).

TABLE I

| Method | PSNR↑ | SSIM↑ | MS-SSIM↑ | LPIPS↓ |
|---|---|---|---|---|
| PointAvatar | 25.0 | 0.903 | 0.936 | 0.0717 |
| FLARE | 27.9 | 0.904 | 0.946 | 0.0602 |
| INSTA | 32.5 | 0.953 | 0.977 | 0.0453 |
| Prism Avatar | 31.3 | 0.942 | 0.970 | 0.0590 |
| (before binarization) | | | | |
| Prism Avatar | 32.0 | 0.944 | 0.973 | 0.0593 |
| (after binarization) | | | | |
| Prism Avatar | 30.4 | 0.929 | 0.960 | 0.0690 |
| (after export) | | | | |

The prism avatar method was tested on monocular videos released with INSTA as well as multi-view videos released with NerSemble and the RenderMe-360 dataset.

The trained and exported models were animated using head tracking data in a viewer web application for evaluation. They were verified to run at at least 60 fps on the iPhone Pro 14, as well as a 4th generation iPad Pro. They are also fully compatible with the Samsung Galaxy S9, an Android phone released in 2018.

As tested, the average download size for the prism avatar is 70 MB. Google Chrome tabs running the avatar viewer used 206 MB CPU RAM and 46 MB GPU VRAM on average. The low VRAM usage reflects the efficiency of the hybrid representation of the head used by prism avatar.

The quality of our rendered images was measured at different stages of the avatar generation process (e.g., Table I). As shown, the opacity binarization during the second stage of training suppresses small artifacts in the prism avatar model, resulting in a slight improvement in the metrics. Also, there is a slight drop in the image quality introduced by the model export process.

The metrics are compared against three related art head avatar reconstruction methods: PointAvatar, FLARE and INSTA. Monocular videos were used for a fair quantitative comparison. The original non-overlapping train-test splits were used for each video. The results show that the avatar prism method produces high image quality metrics that are competitive with related-art avatar methods which must run on desktop devices with advanced hardware, even though the prism avatar method is a compact distilled model prioritizes edge device compatibility.

According to an embodiment, the AI device 100 can be configured to generate real-time animated 3D neural head avatars on an edge device. The AI device 100 can be used in various types of different situations.

According to one or more embodiments of the present disclosure, the AI device 100 can solve one or more technological problems in the existing technology, such as receive two dimensional (2D) images of a face and generate a 3D animation of the face with high quality, realistic and expressive facial animations together with realistic fine details for other portions of the object, such as hair.

For example, the AI device can address to need of providing creating realistic, expressive and efficient avatars that can be rendered in real-time on devices with limited resources.

Also, according to an embodiment, the AI device 100 can be used in a mobile terminal, a smart TV, a home appliance, a robot, an infotainment system in a vehicle, etc.

For example, the AI device can be applied in a wide range of interactive applications including a digital avatar or computer animation.

In addition, the method can use a neural network to animate a 3D face with facial expressions.

Also, while examples may describe a method utilizing a hybrid 3D model that combines a triangular mesh with texture maps for the face and neck of a head avatar and a collection of triangles with associated neural textures for the hair of the avatar, embodiments are not limited thereto. For example, embodiments of the method utilizing a hybrid 3D model described herein can be applied to any type of 3D object where one portion can be represented with a mesh and another portion having finer details can be represented with the triangles with associated neural textures corresponding to the NeRF (e.g., animals, vehicles, plants and other objects, etc.).

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling a device, the method comprising:
receiving, by a processor, an input two-dimensional (2D) image;
receiving, by the processor, a hybrid three-dimensional (3D) model including a first set of triangles forming a triangular mesh, and a second set of triangles with associated alpha map and neural feature maps, the vertices of both of the first and second sets of triangles including rigging information;
deforming, by the processor, the first and second sets of triangles of the hybrid 3D model based on 3D animation parameters and the rigging information, to generate deformed triangles;
rendering, by the processor, the deformed triangles based on rendering the first set of triangles using a texture mapping technique and rendering the second set of triangles using deferred neural rendering based on the neural feature maps and the alpha map to generate rendered triangles; and
displaying, on a display of the device, an animated 3D object based on the rendered triangles and the input 2D image.

2. The method of claim 1, wherein the first set of triangles correspond to a 3D surface mesh of a 3D morphable model, and
wherein the second set of triangles correspond to a neural radiance field (NeRF).

3. The method of claim 1, wherein the rendering the deformed triangles is based on a three-pass process that includes:
rendering the first set of triangles using the texture mapping technique;
rendering the second set of triangles using the deferred neural rendering based on sampling the neural feature maps and the alpha map, discarding low-opacity pixels, and inputting sampled features and a camera direction to a color prediction neural network to generate a rendered image; and
performing image-space post-processing on the rendered image to generate at least a portion of the animated 3D object.

4. The method of claim 1, further comprising:
receiving predetermined weights for a color prediction neural network; and
rendering the second set of triangles based on the color prediction neural network and the predetermined weights.

5. The method of claim 1, wherein one or more triangles among the first and second sets of triangles have textures mapped to pre-computed textures, and the one or more triangles deform along with the triangles.

6. The method of claim 1, wherein the first set of triangles correspond to a head or neck region of a 3D head avatar, and
wherein the second set of triangles correspond to a hair region of the 3D head avatar.

7. A method for controlling a device, the method comprising:
receiving, by a processor, a video segment of a subject;
fitting, by the processor, a three-dimensional (3D) morphable model to the video segment of the subject to obtain animation parameters for frames of the video segment;
constructing, by the processor, a prism lattice structure over regions of the 3D morphable model designated for neural radiance field (NeRF) rendering, the prism lattice structure being configured to deform in tandem with the 3D morphable model;
training, by the processor, a feature field neural network, an opacity field neural network, and a color prediction neural network within a corresponding canonical space to generate a trained feature field neural network, a trained opacity field neural network, and a trained color prediction neural network; and
generating, by the processor, a hybrid 3D model including a 3D surface mesh for the 3D morphable model and a neural radiance field (NeRF) defined within the prism lattice structure based on the trained feature field neural network, the trained opacity field neural network, and the trained color prediction neural network.

8. The method of claim 7, wherein the training the feature field neural network, the opacity field neural network, and the color prediction neural network is based on:
rendering images by casting rays, determining ray intersections with the 3D surface mesh and the prism lattice, and sampling feature and opacity fields;
comparing rendered images to ground truth images; and
minimizing a difference between the rendered images and the ground truth images.

9. The method of claim 7, further comprising:
refining the trained opacity field neural network to favor binary values and associating each ray with a single feature vector from an opaque triangle of the prism lattice structure.

10. The method of claim 7, further comprising:
pruning triangles from the prism lattice structure;
creating texture maps for remaining triangles of the prism lattice structure, including an alpha map and two feature maps;
obtaining a rigged triangular mesh; and
outputting the rigged triangular mesh and the texture maps.

11. The method of claim 10, further comprising:
transmitting an exported hybrid 3D model based on the rigged triangular mesh and the texture maps.

12. A device, comprising:
a display configured to display an image;
a memory configured to store animation information; and
a controller configured to:
receive an input two-dimensional (2D) image,
receive a hybrid three-dimensional (3D) model including a first set of triangles forming a triangular mesh, and a second set of triangles with associated alpha map and neural feature maps, the vertices of both of the first and second sets of triangles including rigging information,
deform the first and second sets of triangles of the hybrid 3D model based on 3D animation parameters and the rigging information, to generate deformed triangles,
render the deformed triangles based on rendering the first set of triangles using a texture mapping technique and rendering the second set of triangles using deferred neural rendering based on the neural feature maps and the alpha map to generate rendered triangles, and
display an animated 3D object based on the rendered triangles and the input 2D image.

13. The device of claim 12, wherein the first set of triangles correspond to a 3D surface mesh of a 3D morphable model, and
wherein the second set of triangles correspond to a neural radiance field (NeRF).

14. The device of claim 12, wherein the controller is further configured to:
render the first set of triangles using the texture mapping technique,
render the second set of triangles using the deferred neural rendering based on sampling the neural feature maps and the alpha map, discarding low-opacity pixels, and inputting sampled features and a camera direction to a color prediction neural network to generate a rendered image, and
perform image-space post-processing on the rendered image to generate at least a portion of the animated 3D object.

15. The device of claim 12, wherein the controller is further configured to:
receive predetermined weights for a color prediction neural network, and
render the second set of triangles based on the color prediction neural network and the predetermined weights.

16. The device of claim 12, wherein one or more triangles among the first and second sets of triangles have textures mapped to pre-computed textures, and the one or more triangles deform along with the triangles.

17. The device of claim 12, wherein the first set of triangles correspond to a head or neck region of a 3D head avatar, and wherein the second set of triangles correspond to a hair region of the 3D head avatar.

18. The device of claim 12, wherein the hybrid three-dimensional 3D model is based on constructing a prism lattice structure over regions of a 3D morphable model designated for neural radiance field (NeRF) rendering, the prism lattice structure being configured to deform in tandem with the 3D morphable model.

19. The device of claim 18, the prism lattice structure is a pruned prism lattice structure including triangles with associated opacity values that are greater than or equal to a predetermined opacity value.

20. The device of claim 12, wherein the hybrid three-dimensional 3D model is generated based on outputs of a trained feature field neural network, a trained opacity field neural network, and a trained color prediction neural network.
